(19) United States
(12) Patent Application Publication
(10) Pub. No.: US 2018/0133747 A1
(43) Pub. Date: May 17, 2018

(54) CONCRETE JOINT FILLING KIT, METHOD AND DEVICE

(71) Applicant: Solid Solution Products, Inc., Huntington Beach, CA (US)

(72) Inventor: Brian Bowers, Lake Forest, CA (US)

(21) Appl. No.: 15/821,580

(22) Filed: Nov. 22, 2017

Related U.S. Application Data
(63) Continuation-in-part of application No. 15/251,644, filed on Aug. 30, 2016.

(51) Int. Cl. B05C 17/005; B05D 1/26

(52) U.S. Cl. CPC B05C 17/0052; B05C 17/00503; B05D 1/265

(57) ABSTRACT

A system and method for filling joints in concrete. The system includes an A-side joint filler compound portion, a B-side joint filler compound portion, and a liquid pigment portion, which are mixed together in a mixing container initially containing only the A-side joint filler compound portion. The portions are mixed using a mixing rod. An elongate nozzle is then attached to the mixing container, and the mixing container added to an application gun for application to the joint.

### CROSS-REFERENCE TO RELATED APPLICATIONS

This application is a continuation in part of U.S. patent application Ser. No. 15/251,644, filed on Aug. 30, 2016, the entire content of which is expressly incorporated herein by reference.

### STATEMENT RE: FEDERALLY SPONSORED RESEARCH/DEVELOPMENT

Not Applicable

### BACKGROUND

The system and method herein relates to a system and method for filling “control” or “saw-cut” joints and “cold” or “expansion” joints in concrete floors.

In placement of concrete floors there are normally two types of joints. Cold or expansion joint result when a section of a concrete floor is placed/pour by a previous section of concrete floor that was placed earlier that has hardened. Control or saw-cut joints are made when a large section of floor is placed. The control or saw-cut joints control cracking in large sections or slabs of concrete floor. The control or saw-cut joints are made early on in the placement of concrete floor, specifically, after the floor has been troweled and the floor surface finished, but before the concrete has totally set. A pattern of saw-cuts are uniformly cut throughout the newly placed concrete floors. These saw-cuts depth are normally ¼-⅓ the thickness of the floor and placed uniformly cross the floor surface. Concrete shrinks as it hardens and the pattern of saw-cuts helps eliminate random cracking.

Once the entire concrete floor have been installed normally after 30 days of curing, both the control/saw-cut and cold/expansion joint are often filled with a joint filler.

The joint filler materials normally consist of a Part A and Part B liquid. When Part A is mixed with Part B, the mixed parts creates a semi-ridged rapped curing elastomeric joint filler. Unfortunately, once Part A and Part B are mixed with each other, they set very fast so that they have to be applied to the joint quickly before they set. The quick setting nature of Parts A and B after being mixed limits the methods and apparatus for applying the joint filler materials to the joint.

The method and apparatus for filling/applying fast setting joint fillers in concrete joints are limited to using a plural metering electric pump or with a dual cartridge loaded in a dual cartridge gun.

Plural metering pump normally has two lager tanks (where Parts A and B are pour into). The tanks hold 3 or more gallons of part A and part B each. Through the system, the two liquids are pumped/metered though gear pumps and hoses. The gear pumps and hoses take the two liquids to a mixing manifold that combine the two liquids in an attached static mixing tube. The end of the static mixing tube is placed over to the joint and directs the mixed liquids into the concrete joint. The plural metering pumps are expensive and require a thorough cleaning after each use to work properly. This increases the time and cost to operate the machine. This system is known to have problems during use and often malfunction during use, which is costly for the project.

Dual cartridges are two 150 ml, 300 ml or 750 ml cartridge/cylinders/tubs connected to a static mixing tube attached by a retaining nut. Each of the dual cartridges contains either part A or part B. The cartridges are then placed into the dual cartridge gun, which advances plungers inside the cartridges pushing the liquid out a nozzle of the cartridges. An attached static mixing tube covering both nozzle of the cartridge held by a retaining nut then directs the mixed parts A and B to the concrete joint.

Dual cartridges greatly increases the joint filler cost. They are very problematic because portions of the two liquids do not properly mix through the static mixing tube. This leaves gummy/gooey spots in the joint filler. Additionally, cartridges have a limited shelve life because the liquid ingredients inside the cartridges separate and are difficult to mixed back together.

According, there exists a need for an effective joint filling system and method.

### BRIEF SUMMARY

Disclosed is a system for filling concrete control/saw-cut and cold/expansion joints with fast setting fillers. The system may consist of a different packaging, mixer that is designed for the system and an optional special designed bottle-gun for the application of the joint filler.

The system may consist of three liquid elements, namely, an A-side portion, which is short filled in the bottle. The bottle may be a ½ gallon or quart bottle. By short filled, this means that the liquid does not fill the entire bottle but a portion of the bottle is empty. Short filling the bottle with part A allows room for adding part B liquid and pigment liquid into the bottle. The B-side liquid may be packaged in different size spout bags. Additionally, the pigment liquid may be packaged in different size spout bags. The size of the bottle and bags may be determined by the total quantity of joint filler to be mixed. One-quart unit/volume when adding part B and pigment into the quart bottle containing part A makes a total of one-quart of liquid.

Once the part B liquid and pigment liquid are poured into the part A bottle, part B liquid and the pigment liquid are mixed with a special designed mixer that can go inside the bottle. The special designed mixer is also powered using electric drill. The mixer may have a splash and wiper portion that contains the liquid while mixing and acts as wiper/cleaner when removing the mixer from the bottle.

Once the product in thoroughly mixed, a nozzle cap may be attached to the bottle. The nozzle allows the user to turn the bottle upside down and squeeze the bottle by hand directing the liquid into the concrete joint.

For a larger size bottle (e.g. ½ Gal), the bottle can be placed into a special designed bottle-gun rather than squeezing the bottle by hand. The bottle gun compresses the already mixed joint filler into the extended nozzle directed into the joint.

One of aspects of the present system and method relate to a premeasured unit of part A packaged in a bottle that is also used for pouring premeasured part B and premeasured pigment bags into the bottle containing part A. Part A, Part B and the pigment liquid are mixed together using a special designed mixer. Having the pigment not already in either the part A or B allows flexibility of adding different colors so that that the joint filler can be color matched to the concrete with the joint to be filled. Secondly, for large size bottle, a gun is used to compress and restrain the bottle as the user dispenses the joint filler into the concrete joint.

Disclosed is a system for filling concrete control/saw-cut and cold/expansion joints. The system consists of three liquid elements, namely, an A-side portion, a B-side portion, which, when combined, create the liquid compound, and an optional liquid pigment, which allows a user to match the color of the compound formed by the A and B-side portions to the color of the concrete surrounding a joint being filled. When the A-side and B-side portions are mixed, they from a hybrid aliphatic polyurea compound which hardens in a short time. The disclosed hybrid aliphatic polyurea compound is suited to both indoor and outdoor use. Particularly in regard to outdoor use, the compound offers about 600% elongation and hardens to about 80 durometer. The compound may also be UV-tolerant, which is one contributing factor to the compound's high color stability. The A-side portion may come in a mixing container, sized to match typical job sizes, which prevents a requirement to store excess inventory, into which both the B-side portion and the liquid pigment may be added. The combined A-side, B-side, and liquid pigment portions may be mixed in the mixing container by purpose made mixing rod powered by a cordless drill. The mixing rod includes a rod portion which may be inserted in to the chuck of the cordless drill on a first end, and blades attached to the rod portion at an opposite end. A wipe disc includes a wipe disc aperture to allow the wipe disc to slide up and down the rod portion to cover an opening of the mixing container. To mix the compound, the blades are inserted in to the mixing container and the cordless drill powered on. Once mixing is complete, the mixing rod is withdrawn with an upward and sideways movement, and the wipe disc slid along the rod portion to remove any residual compound on the rod portion. An elongated nozzle is then attached to the mixing container, and the mixing container with the elongated nozzle is placed in an application gun. A user may hold the application gun with the user's arm handing downward so that the elongated nozzle is as close to the joint as possible. Using the application gun, the user, in a standing position, applies the compound to the joint.

The A-side, B-side and pigment portions extended shelf life when compared to typical polyurea cartridges, and unlike known polyuria cartridges, the pigment portion offers the possible of more than a single color for the disclosed joint filling system.

The system for filling a joint formed in an upper horizontal surface of a concrete slab includes a deformable mixing container having an opening with an exterior threaded portion, a neck portion and a bottom surface, the deformable mixing container defining an interior cavity, an elongate nozzle, a fitting with an interior threaded portion engagable to the nozzle and the exterior threaded portion of the deformable plastic bottle, a liquid A-side joint filler compound portion disposed in the deformable mixing container and filling less than 90% of the interior cavity of the deformable mixing container, and an application gun sized and configured to receive the deformable mixing container, the application gun having an enlarged base for receiving the bottom surface of the deformable mixing container, the enlarged base being larger than the bottom surface of the deformable plastic bottle, a U-shaped notch attached to a frame of the application gun for receiving the neck portion of the deformable mixing container. The system further includes a liquid B-side joint filler compound portion disposed within a first pouch, a mixing rod having a first end portion sized and configured to be mounted to a rotation powering device, a rod portion and an opposed second end portion having two or more blades for mixing the liquid A-side joint filler and the liquid B-side joint filler, and a wiper disc with a hole formed at a central portion of the wiper disc, the hole being sized to have a diameter greater than an outer diameter of the rod portion for wiping the liquid joint filler as the mixing rod is lifted out of the deformable plastic bottle when mixing the liquid A-side joint filler compound portion, the liquid B-side joint filler compound portion, an outer diameter of the wiper disc being greater than an inner diameter of an opening of the deformable mixing container.

The two or more blades of the mixing rod may have material removed to form apertures.

The application gun may further include a cover assembly.

The cover assembly of the application gun may include a hinge portion, an upper face plate, a leg portion, and a latch. The latch includes a handle, a pin, a biasing element, and a cutout. Further, the handle of the latch moves between two positions within the cutout. The biasing element of the latch biases the handle of the latch.

The system further includes a liquid pigment, the liquid pigment being mixed with the liquid A-side and B-side joint filler compound portions in the mixing container.

The disclosure further includes a method of applying a joint filler to a joint in a horizontal concrete surface. The method includes the steps of inserting a liquid B-side joint filler compound portion into a deformable mixing container having a liquid A-side joint filler compound portion therein, and attaching a mixing rod to a collet of a rotation powering device to impart rotation to the mixing rod. The method further includes inserting an end of the mixing rod comprising a plurality of blades into an opening of the deformable plastic bottle, rotating the mixing rod under power of the rotation powering device to mix the liquid A-side joint filler compound portion and the liquid B-side joint filler compound portion, and holding a wiper disc against the opening of the deformable mixing container while removing the mixing rod from the deformable mixing container; stopping rotation of the mixing rod. The method also includes lifting the plurality of blades out of the deformable mixing container, and attaching an elongate nozzle to the opening of the deformable mixing container so that a user can stand generally upright while an application nozzle of the elongate nozzle is closely adjacent to the joint in the horizontal concrete surface.

The method may further include placing the deformable mixing container in an application gun comprising a trigger. The method may also further include operating the trigger to provide pressure on the deformable mixing container, expelling compound from the nozzle.

The rotation powering device of the method may be a cordless drill.

The method may further include, after the step of inserting the liquid B-side joint filler compound portion into a deformable mixing container having a liquid A-side joint filler compound portion therein; inserting a liquid pigment into the deformable mixing container having the liquid A-side joint filler compound portion therein.

Also disclosed is an application gun for dispensing a liquid joint filler out of a deformable mixing container onto a joint formed in a horizontal concrete surface. The application gun includes a frame defining an interior and having a notch for receiving a neck portion of the deformable mixing container, and a handle and trigger assembly, the handle and trigger assembly attached to the frame. The application gun further includes a base traversable, in the interior, between a first position wherein the base is disposed closer to the handle and trigger assembly when compared to the notch and a second position wherein the base is disposed closer to the notch when compared to the handle and trigger assembly, and first and second guide rods attached to the base and slidable within the frame to stabilize the base as the base is traversed between the first and second positions. Finally, the application gun includes a push rod attached to the base and actuatable with the trigger to incrementally move the push rod and the base forward toward the notch as the trigger is repeatedly depressed.

The application gun may further include a cover assembly. The cover assembly may include a hinge portion, an upper face plate, a leg portion, and a latch. The latch may include a handle, a pin, a biasing element, and a cutout. Finally, the handle may move between two positions within the cutout.

The system may include an application gun which includes a release lever and a grip.

The disclosure also includes a mixing device for mixing a liquid side-A joint filler compound portion and a liquid side-B joint filler compound portion within a deformable mixing container having an opening. The mixing device includes an elongate rod portion having a cylindrical configuration, the elongate rod portion being longer than a depth of the deformable mixing container, and a plurality of mixing blades having a diameter smaller than an opening of the deformable mixing container is disposed on a distal end of the elongate rod portion and a proximal end adapted to be secured to a collet of a rotation powering device. The mixing device further includes a wiper disc having an outer diameter larger than the opening of the deformable mixing container and a central hole slightly larger than an outer diameter of the rod portion for wiping the mixed liquid side-A joint filler compound portion and liquid side-B joint filler compound portion off of the rod portion as the plurality of mixing blades are traversed out of the deformable mixing container.

In another aspect, a mixing device for mixing a liquid side-A joint filler compound portion and a liquid side-B joint filler compound portion within a deformable mixing container having an opening is disclosed. The mixing device may comprise an elongate rod portion having a cylindrical configuration, the elongate rod portion being longer than a depth of the deformable mixing container; a plurality of mixing blades having a diameter smaller than an opening of the deformable mixing container is disposed on a distal end of the elongate rod portion and a proximal end adapted to be secured to a collet of a rotation powering device; and a wiper disc having an outer diameter larger than the opening of the deformable mixing container and a central hole slightly larger than an outer diameter of the rod portion for wiping the mixed liquid side-A joint filler compound portion and liquid side-B joint filler compound portion off of the rod portion as the plurality of mixing blades are traversed out of the deformable mixing container.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a perspective view of various components of a system for filling a joint in a concrete slab;

FIG. 2 illustrates a perspective view of the combination of components of the system;

FIG. 3 illustrates a perspective view of the mixing of the components of the system;

FIG. 4 illustrates a perspective view of the mixing rod and mixing container of the system;

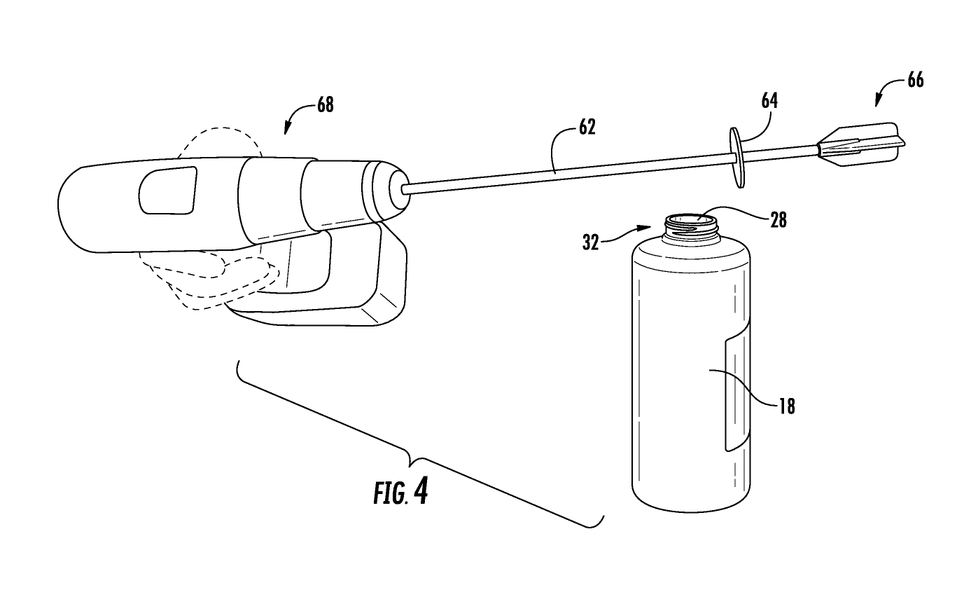

FIG. 5 illustrates an exploded perspective view of the mixing container, elongate nozzle, and a fitting;

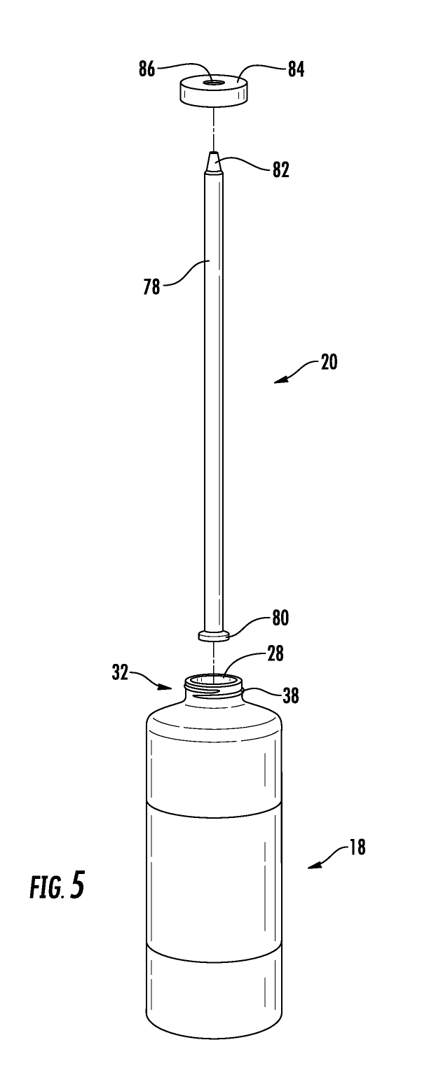

FIG. 6 illustrates a perspective view of the mixing container, elongate nozzle, and a fitting;

FIG. 7 illustrates a perspective view of one embodiment of an application gun of the system;

FIG. 8 illustrates another perspective view of the application gun of the system;

FIG. 9 illustrates a perspective view of the application gun of FIG. 8 with a mixing container loaded in the application gun;

FIG. 10 illustrates a perspective view of the application gun and the mixing container shown in FIG. 9 with a cover assembly in a closed position;

FIG. 11 illustrates a perspective view of the application gun of FIG. 10 with the cover assembly in a locked position;

FIG. 12 illustrates a perspective view of a user holding the application gun with a distal end of the elongate nozzle adjacent to the ground so that the user need not bend over when applying a compound to a joint in the ground during filling of the joint;

FIG. 13 illustrates a perspective view of the application gun with a roller support;

FIG. 14 illustrates a perspective view of the user holding the application gun shown in FIG. 13; and

FIG. 15 illustrates the application gun with the roller support being adjustable.

### DETAILED DESCRIPTION

Disclosed is a system for filling joints in concrete surfaces. The system 10 may consist of three liquid elements, namely, an A-side portion 12, which includes a portion of the liquid compound, a B-side portion 14, which includes another portion of the liquid compound, and an optional liquid pigment 16, which allows a user to match the color of the compound formed by the A and B-side portions 12, 14 to the color of the concrete surrounding a joint being filled. The A-side portion may come in a mixing container 18 into which both the B-side portion and the liquid pigment may be added. The mixing container is sized to match typical job sizes, which prevents a requirement to store excess inventory. The A-side, B-side and pigment portions have an extended shelf life when compared to typical polyurea cartridges, and unlike known polyuria cartridges, by separating the pigment portion from the A-side and B-side portions, the user can select one of a plurality of pigment portions to match the joint filler with the concrete of the joint being filled. Alternatively, the user can select one of the plurality of pigment portions that complement and do not match the color of the concrete with the joint being filled. For example, Brown concrete can be filled with white or black color joint filler. This offers the user with the possibility of mixing any pigment at the time of doing the joint filling. The combined A-side, B-side, and liquid pigment portions may be mixed in the mixing container by a mixing rod 60 (i.e., special designed mixer) attached to, and powered by, a cordless drill 68. The mixing rod includes a rod portion 62 which may be inserted in to the chuck of the cordless drill on a first end, and blades 66 attached to the rod portion on a second, opposite end. A wipe disc 64 (i.e., splash and wiper portion) includes a wipe disc opening 72 to allow the wipe disc to slide up and down the rod portion in order to cover an opening 28 of the mixing container. The mixing rod outer diameter is sized to be about equal to the inner diameter of the opening 28 so that as the rod portion is slide up and down, the liquid is wiped and kept in the bottle. To mix, the blades and the rod portion are inserted in to the mixing container and the cordless drill powered on. When the drill is powered on to rotate the mixing rod, the liquid may splash inside the bottle. Fortunately, the outer diameter of the wipe disc 64 is greater than the mouth of the bottle so that the wipe disc 64 keeps the liquid in the bottle. Once mixing is complete, the mixing rod is withdrawn with an upward and sideways movement, and the wipe disc slid along the rod portion to remove any residual compound on the rod portion. An elongated nozzle is then attached to the mixing container, and the mixing container with the elongated nozzle is placed in an application gun. A user may hold the application gun with the user's arm extending downward so that the elongated nozzle is as close to the joint as possible. The user fills the joint with the joint filler by hand. Manual or hand operation is normally done for smaller jobs that may require one or two quarts of joint filler. Using the application gun (i.e., bottle gun), the user, in a standing position, may apply the compound to the joint. Bottle gun operation may be done for larger jobs requiring ½ gallon or more of joint filler. In this regard, the part A portion may be provided in the bottle which is either a quart size or a ½ gallon size.

Additionally, since the pigment portion is not premixed with either one of part A or part B, part A and part B can be purchased, stored and saved for future use. If the concrete in the future has a particular color, the pigment matching that color can be selected and mixed with part A and part B at the time of doing the joint filling job.

Moreover, the part A portion, part B portion and the pigment portion are premeasured and packaged in the bottle and bags to make up either one quart of joint filler or ½ gallon of joint filler depending on the size of the job. Although the bottle size is one quart or ½ gallon as discussed herein, other sizes are also contemplated including but not limited to 1 gallon.

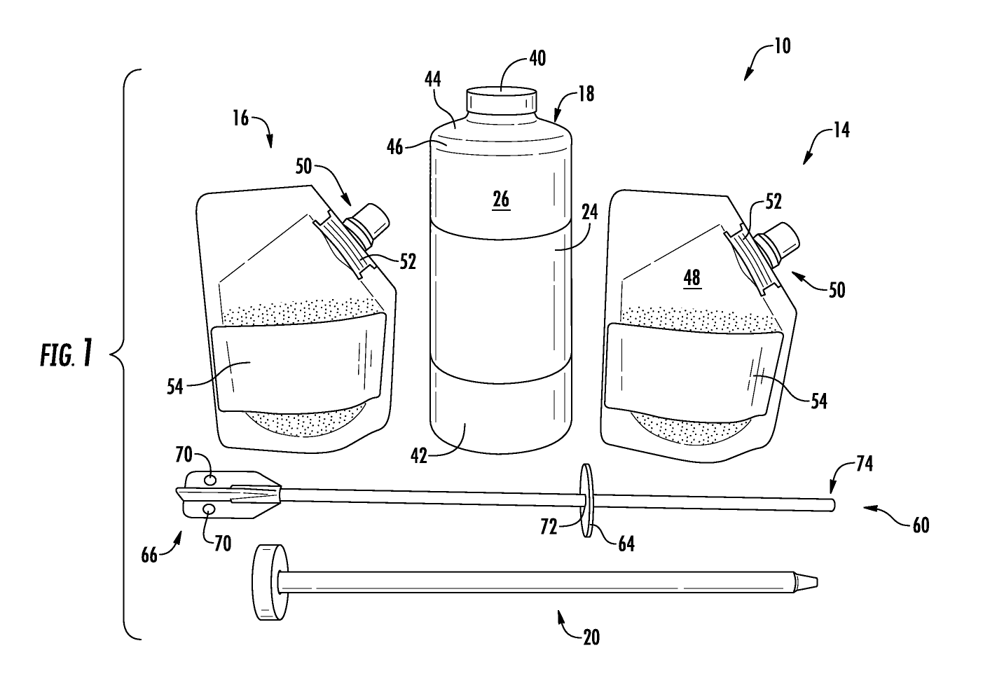

Referring now to the drawings, FIG. 1 shows a system 10 for filling a visible joint in a concrete surface. The system 10 fills joints in concrete surfaces with a liquid compound which rapidly hardens to a solid compound, at a hardness of between 60-100 durometer, and preferably about 80 durometer. The system 10 may have three liquid elements, namely, an A-side portion 12, which includes a portion of the liquid compound, a B-side portion 14, which includes another portion of the liquid compound, and a liquid pigment 16, which allows a user to match the color of the compound formed by the A, B-side portions 12, 14 to the color of the concrete surrounding a joint being filled. Alternatively, the user can select the color of the liquid pigment 16 which is different from the color of the concrete. When the A-side portion 12 and B-side portion 14 are mixed, they from a hybrid aliphatic polyurea compound which is volatile and hardens in a short time. The disclosed hybrid aliphatic polyurea compound is suited to both indoor and outdoor use. Particularly in regard to outdoor use, the compound offers at least between 400% to 800% elongation and preferably at least 600% elongation and, as previously mentioned, hardens to at least about 60 durometer, and preferably about 80 durometer. The compound is also UV-tolerant, which is one contributing factor to the compound's high color stability. Typically, the compound must be inserted into the joint within about 10 minutes after the A-side portion 12 and the B-side portion 14 come into contact with each other since when they come into contact with each other, the A-side portion 12 and B-side portion 14 begin to harden. The mixing container 18, which initially contains the A-side portion only, may be placed in a purpose-made application gun, discussed below. The application gun allows a user to dispense the compound evenly through the maintenance of equal pressure on the mixing container. The compound exits the container through an elongated nozzle 20. The elongated nozzle may be of varying lengths. Preferably, the elongated nozzle is sufficiently long so that a distal end of the elongated nozzle can be placed adjacent to the joint of the ground without the user having to bend over or stoop, but rather remain generally upright. By way of example and not limitation, the length of the elongate nozzle 20 may be greater than about 6 inches and up to about 18 inches long. Preferably, the length of the elongate nozzle 20 may be about 12 inches long. Alternatively, the nozzle 20 maybe a short tip and have a length less than about 6 inches, and is preferably about 1 to 2 inches long.

The B-side portion and A-side portion may be mixed together in a 1-7 ratio. By doing this and adding certain catalysts, the joint filler after being filled in the joint of the concrete may have a shaved time of about one hour. Other ratios also contemplated including but not limited to ratios between about 1-7 to about 1-4 with respect to the B-side portion and the A-side portion.

This system 10 offers many advantages. First, the individual portions of the compound may be stored for long, shelf-stable periods. Second, the compound may be color matched to the concrete. More beneficially, the user may buy a sufficient amount of A-side portion 12 and B-side portion 14 and even if the person purchases the wrong liquid pigment 16, the worker can discard the mixed A-side portion 12 and B-side portion 14 mixed with the wrong liquid pigment 16 and salvage the remaining unmixed A-side portion 12 and B-side portion 14. Third, the elongate nozzle may be sufficiently long so as to allow a user to apply the compound using the application gun to remain standing erect, thereby avoiding uncomfortable positions such as kneeling or stooping. A shorter nozzle may be used but that would require the user to kneel or stoop in order to apply the compound into the joint of the concrete slab. Fourth, due to the added mobility of remaining erect, the worker can work faster so that the compound may be applied evenly over the entire length of the joint before the compound hardens. The compound may harden to about Shore 80-A. Fifth, the compound may be self-leveling and may have 600% elongation, ensuring no further need to work the compound in order to fill any joints. Finally, due to the volatility of the compound, filling of the joint may be made quickly, minimizing the need for closure of portions of the business where the concrete slab is located when the concrete slab is in a commercial setting, or preventing enjoyment in a residential setting, due to the safety hazard posed by broken concrete.

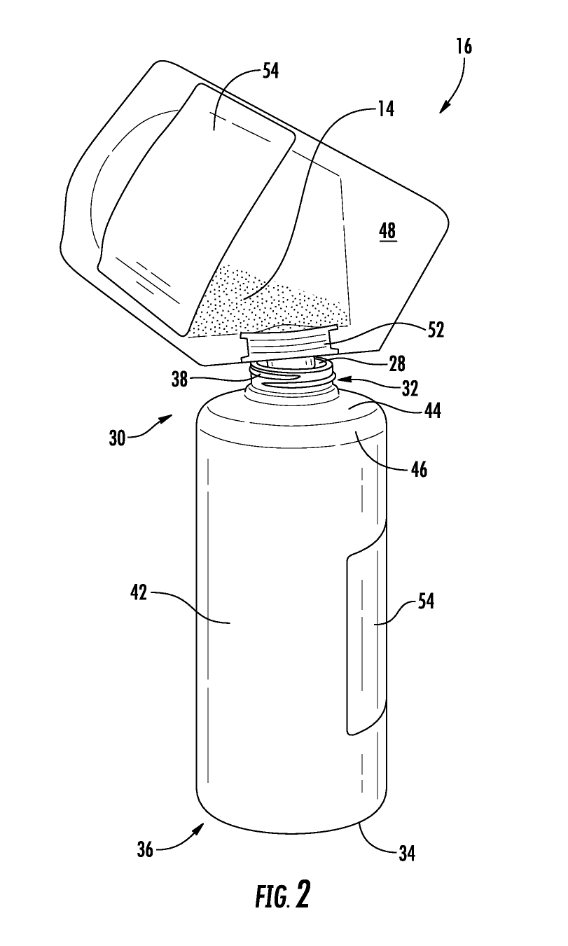

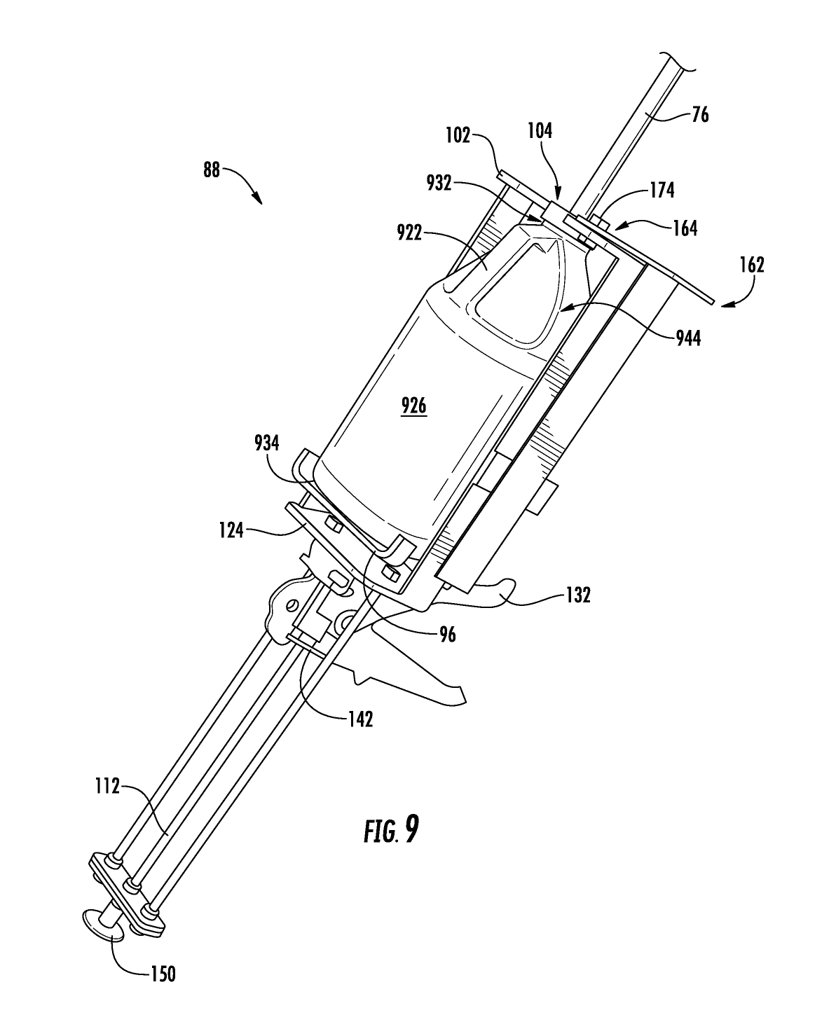

Referring to FIGS. 1 and 2, the A-side portion of the compound may be packaged in a mixing container 18. The mixing container 18 may be a plurality of sizes. For example, the mixing container may be sized to accommodate a quart of mixed compound, or a half-gallon of mixed compound. The mixing container 18 may be of any shape which will fit the application gun, which is discussed in greater detail below. Preferably, the mixing container 18 may have a cylindrical body shape and a generally flat bottom. The mixing container may or may not include a handle 922 (FIG. 9) for ease of manipulating the mixing container. The mixing container may have an indicator 24, for example, a label, attached to an exterior surface 26 to indicate the proportion of compound which will result from the mixing of the various components of the system corresponding to the size of the mixing container and the A-side portion packaged therein. The mixing container 18 may also include an opening 28 on one end 30, a neck portion 32 just below the opening, and a bottom surface 34 on an end 36 opposite that with the opening. The neck portion may include an attachment structure 38, for example, threads or a twist and lock structure, or a snap fit structure. A corresponding structure (not shown) is formed on the inside of a cap 40, which covers the opening of the mixing container. A body portion 42 of the mixing container is located between the bottom surface and a transition portion 44. The transition portion extends between the neck and the body, and transitions a wall 46 of the mixing container from a diameter of the neck to a diameter of the body. The body is substantially cylindrical in shape. The mixing container may be made of any material which will retain its shape when stored, but will readily deform when pressure is applied along a longitudinal axis of the mixing container.

The B-side portion 14 of the compound is packaged in packaging 48 which may be an envelope or packet, or any sealed container which would allow transfer to the mixing container while minimizing spillage. The packaging may be provided with a spout 50. The packaging may be made from a plastic, or a non-permeable cloth, or any other material that contains the B-side portion without deteriorating or allowing the liquid to spill. The packaging 48 may be sealed on each side, including being sealed around a base 52 of the spout, which may be an independent component, or may be formed as part of the packaging, and may be made of a plastic, an alternate composite, or a metal, for example. The B-side portion may be packaged in a package which will form as little waste as possible when the B-side portion of the compound 58 is emptied in the mixing container. The B-side packaging may also have an indicator 54, such as a label, to indicate the proper corresponding A-side portion, in order to avoid mixing mis-matched portions, which may result in non-functional compound, or a compound with degraded performance.

The liquid pigment 16 may be packed similarly to the B-side portion. The packing of the liquid pigment may also have an indicator 54, such as a label, to indicate the proper corresponding A-side and B-side portions, in order to avoid mixing mis-matched portions, which may result in a lighter or darker color tint than anticipated.

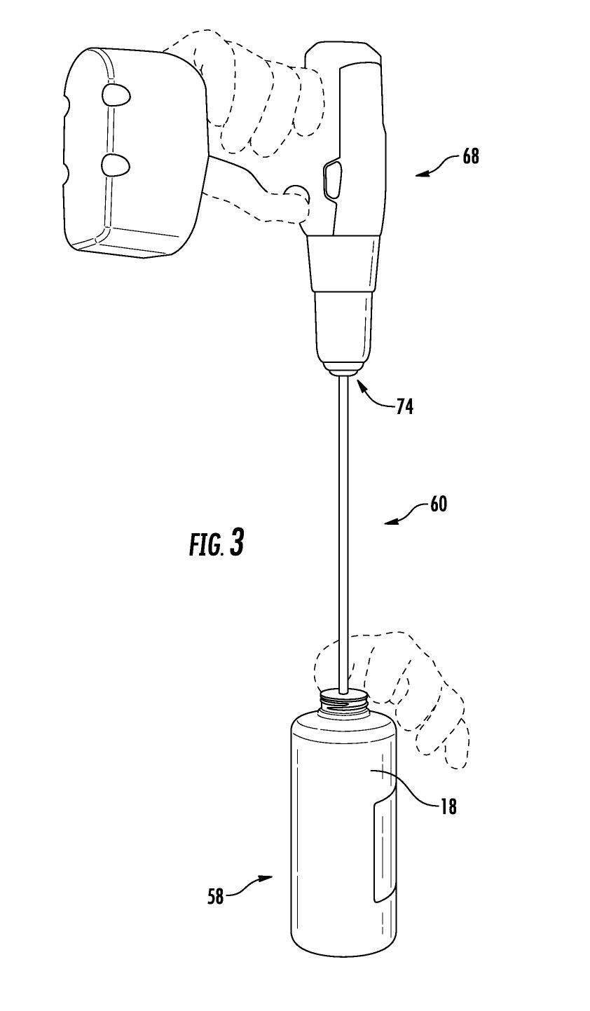

As shown in FIG. 2, in use, the B-side portion 14, and the liquid pigment 16, with like portion indicators 54 as the A-side portion are combined with the A-side portion 12 by adding the B-side portion and the liquid pigment to the mixing container 18. The combination of the A-side and B-side portions in the mixing container creates the compound 58 (FIG. 3) for filling the joint. The liquid pigment is added in order to provide a color tint to the compound formed by the A-side portion, B-side portion, to match the color of the concrete being fixed.

However, once the portions have been combined in the mixing container 18, the portions may still not be well mixed. With reference to FIGS. 1 and 3, the system further includes a mixing rod 60. The mixing rod may have three components, a rod portion 62, a wipe disc 64, and mixing elements or blades 66. One end of the rod portion of the mixing rod may be attached to a chuck of a cordless drill 68. Other rotation powering devices can be used in place of the cordless drill, including corded drills and rotary power tools, such as those sold under the DREMEL® brand. Attached at the opposite end of the mixing rod are mixing elements or blades. The mixing rod may have four blades, as shown in FIG. 1, or may have more or fewer blades. The four blades are located 90° apart from each other. If there are fewer blades or more blades, then the blades are equally radially spaced apart from each other about the longitudinal axis of the rod itself. Further, each of the blades may have some portion of material removed to form apertures 70, which still allow the blades to mix the compound, but prevent too much friction between the blades and the compound 58. For example, the apertures may be a circular hole 70 located on one or more of the blades. The wipe disc may have an opening 72 near the center. The opening may be circular, square, or any shape which accommodates the rod portion, which passes through the opening, allowing the wipe disc to slide along the rod portion between the blades and the end 74 opposite the blades. Preferably, the opening 72 is circular and the rod portion 62 of the mixing rod 60 is also circular having a diameter which is equal to or within a few thousandths of an inch smaller than the diameter of the opening 72 so that the rod portion 62 of the mixing rod 60 can rotate within the opening 72 and also wipe off any compound 58 from the rod portion 62 of the mixing rod 60 as the mixing rod 60 is being lifted up and sideways in order to remove the mixing rod from the mixing container 18.

In operation, the blades 66 are inserted in to the mixing container 18, and the cordless drill 68 operated to spin the blades to mix the compound 58 formed in the mixing container. The blades may be moved longitudinally from the neck 32 down to the bottom surface 34 of the mixing container by varying the height of the rotation powering device. The mixing rod may be angled within the opening as well. The relatively large ratio of a circumference of the mixing rod to the opening of the mixing container allows the user to move the blades internally within the mixing container until the blades contact the sides of the mixing container. A user may hold the wipe disc 64 in place at the opening 28 of the mixing container to prevent spillage of the compound 58 as it is mixed by the blades. The wipe disc 64 prevents the splattering compound from spilling out of the mixing container 18. Moreover, holding the wipe disc over the opening as the mixing rod is withdrawn from the mixing container acts to remove compound from the rod portion 62 as the rod portion slides outward through the opening 72 of the wipe disc, ensuring that none of the compound is lost when removing the mixing rod 60 from the mixing container 18. The user may hold the wipe disc down by, for example, placing a finger downward on a top surface of the wipe disc, one finger on either side of the mixing rod, or by wrapping the fingers loosely around the mixing rod, and placing the side of the hand and the pinky on the top of the wipe disc to hold the wipe disc down on the opening, or any other method which allows the wipe disc to remain in place over the opening during mixing of the compound. After a mixing time, which may be, for example, one to five minutes, with two to three minutes being preferred, the mixing rod may be removed using the wipe disc to ensure as much compound as possible stays in the mixing container. The user slowly lifts up the cordless drill 68 which imparts the rotational motion on the mixing rod 60. The blades begin to approach the opening of the container 18 and the wipe disc 64. The blades of the mixing rod 60 cannot proceed through the opening 72 of the wipe disc 64. As such, when the blades are immediately below the wipe disc 64, the user stops the rotation powering device 68 from rotating or spinning the blades and merely lifts up the blades out of the container 18 and places the rag over the blades is to prevent spillage of the compound stuck on the blades from dripping on the ground or other surface.

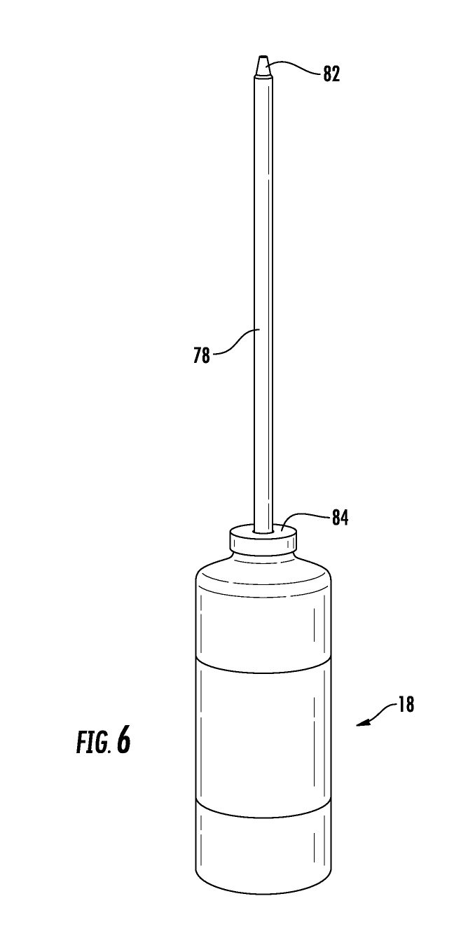

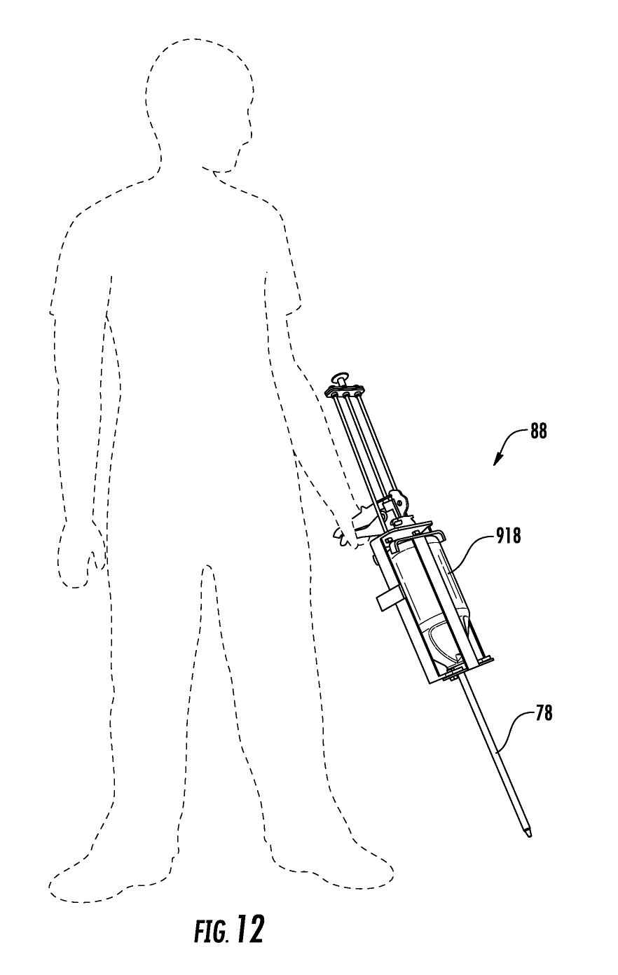

After the mixing rod is removed, an elongate nozzle 20 may be attached to the mixing container 18. The elongate nozzle, which may be of varying length, but made in a range of lengths such that a user may operate the system from a standing position while still being able to apply the compound to the joint with the elongate nozzle as close to the joint as possible, as shown in FIG. 12. An application position where the elongate nozzle is as close to the joint as possible leads to the most accurate application of the compound to the joint. The elongate nozzle includes a body 78 with a base 80 on one end, and an application nozzle 82 on the opposite end. The base is sized such that an exterior diameter of the base is co-equal to an exterior diameter of the neck 532. A fitting 84 is similar to the cap 40 of the mixing container, but has an aperture 86 through which the elongate nozzle passes. To attach the elongate nozzle, the base of the elongate nozzle is placed against the neck at the opening 528, and then the fitting is placed on the elongate nozzle, with the application nozzle and the body passing through the aperture until the fitting comes in contact with the neck. There, a corresponding attachment structure (not shown) on the fitting interfaces with the attachment structure 538 on the neck to allow the user to attach the fitting to the neck. The assembled components, ready for the next step, are shown in FIG. 6.

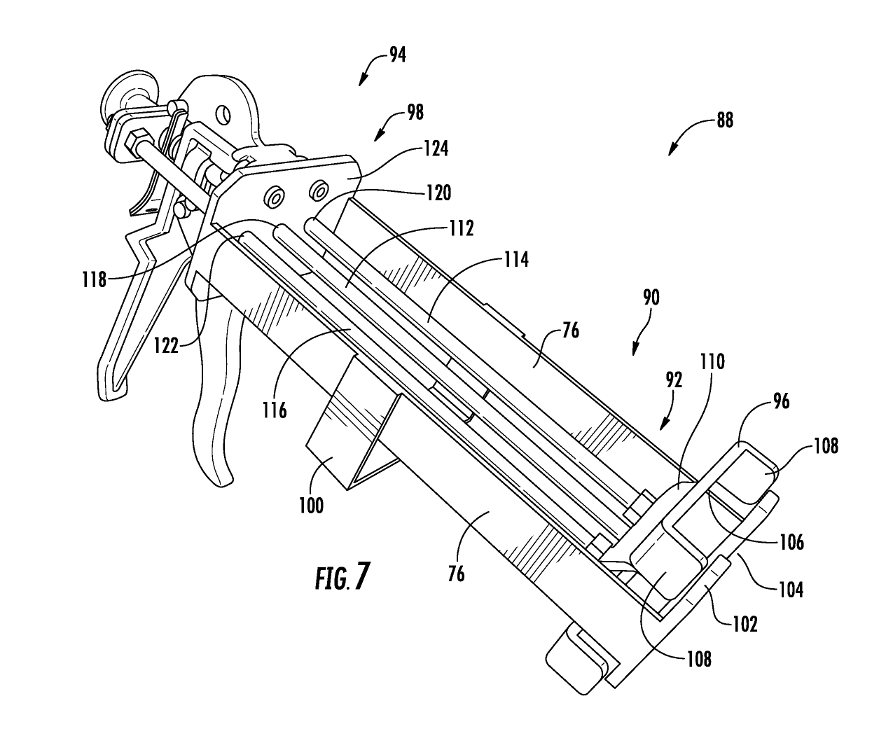

With reference to FIG. 7, the system further includes an application gun 88. The application gun may be optionally used with a 1 quart or 1 gallon size A-side mixing container 18. The compound may be applied by hand from the 1 quart size mixing container. The application gun may include three main portions, a frame 90, a mechanism 94, which is attached proximally of the frame, and a sliding portion 98. The frame 90, which supports the mixing container, may define an interior 92. The distal end of the frame may include a face plate 102 which defines a notch 104. The notch may support the neck portion of the mixing container, as will be described in more detail below. Opposite the face plate is a proximal plate 124 which defines a proximal end of the frame. One or more longitudinal frame elements 76 and traverse frame elements 100 may further define the frame, with the longitudinal frame elements connecting the face plate and the proximal plate, and the traverse frame elements connecting the longitudinal frame elements.

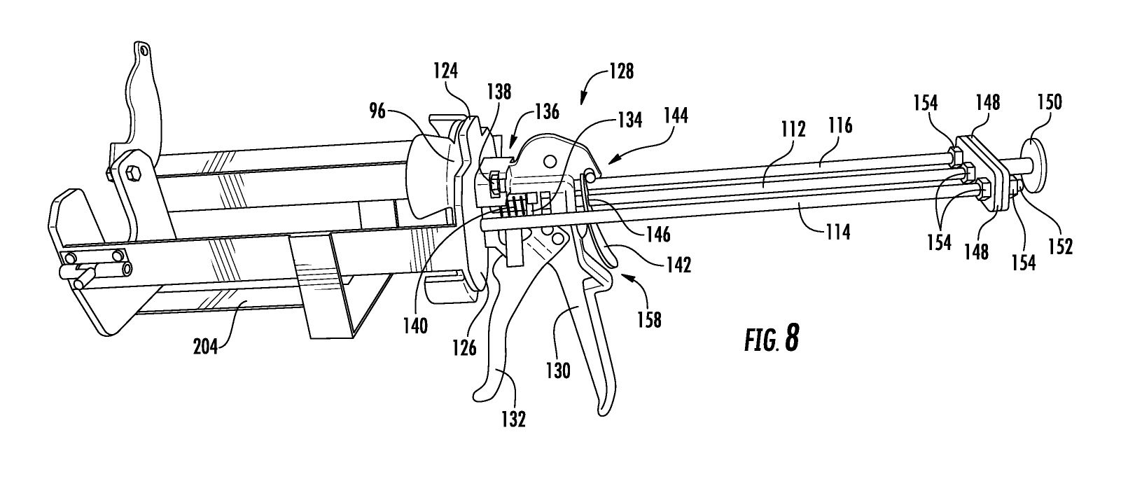

Referring now to FIGS. 7 and 8, mounted to an exterior surface 126 of the proximal plate 124 of the frame 90 is the mechanism 94. A mounting bracket 136 mounts a handle and trigger assembly 128 to an exterior surface of the proximal plate, for example, by mechanical fasteners 138. The handle and trigger assembly may include a handle 130, a trigger 132 hinged to the handle, and a pusher 134 hinged to the trigger. A first biasing element 140 may be placed between the mounting bracket and the pusher. The biasing element may be, for example, a helical spring, a leaf spring, or a cylinder formed from a resilient material. The handle and trigger assembly further includes a release lever 142. The release lever is pinned against the handle and trigger assembly on one end 144. The release lever may further have a push rod pass through 146, which is correspondingly shaped to the push rod 112, which is discussed in further detail below. The release lever may be biased by a second biasing element, which is placed between the release lever and the handle.

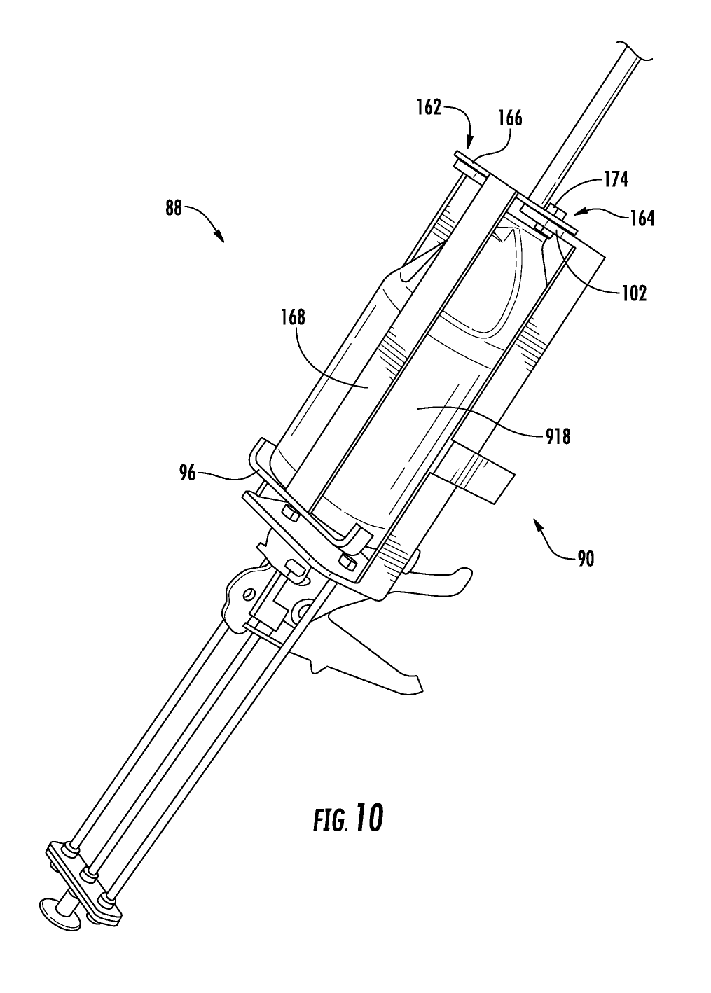

The sliding portion 98 traverses both the frame 90 and the mechanism 94, and slides longitudinally through the proximal plate 124 and in the interior 92 of the frame 90, through the mechanism 94, and the sliding portion has a segment 56 which remains proximal of the mechanism in every position of the sliding portion. On a distal end of the sliding portion may be a base plate 96. The base plate may include a flat surface 106 which corresponds to the bottom surface 34 of the mixing container 18. In operation, the flat surface abuts the bottom surface of the mixing container. The base plate may further include stabilization elements 108, which extend perpendicularly from the flat surface of the base plate. When a mixing container is placed in the application gun 88, as shown in FIG. 10, the stabilization elements surround a periphery of, and extend longitudinally along, an exterior surface 26 of the mixing container 18, stabilizing the mixing container radially. The base plate may move between a position adjacent the face plate 102 of the frame, and a position adjacent a proximal.

Three rods may attach to a surface 110 of the base plate 96 opposite the flat surface 106. One rod is a push rod 112, and is attached near the center of the base plate. Two guide rods 114, 116 may be placed on opposed sides of the push rod 112. One guide rod 114, 116 being placed on either side. Each rod passes through a corresponding aperture 118, 120, 122 in a proximal plate 124 of the frame 90.

From their attachment point, the push rod 112 and the guide rods 114, 116, extend proximally. The push rod passes through a push rod aperture in the proximal plate, through the mounting bracket, through the pusher, the handle, and finally through the release leaver 142 using the push rod pass through 146. The guide rods 114, 116, extend proximally of the base plate through guide rod apertures in the proximal plate.

Near a proximal end, in the segment 56 of the sliding portion 98 which remains proximal of the mechanism 94, each of the push rod 112 and the guide rods 114, 116 may attach to an alignment plate 148. Attached to, and extending from the proximal end of the push rod is a grip 150. When the release lever 142 is engaged, the grip 150 is used to traverse the base plate 96 from the distal end to the proximal end of the interior 92. Alternately, a user may engage the release lever and use the grip to take up any slack between the base plate and a mixing container 18 in the application gun 88. The base plate 96 is shown as being at the proximal end of the interior in FIG. 8. The end of the rods may include threads 152 for attaching the rods to the alignment plate via, a mechanical fastener 154, for example, a nut or a nut and washer combination. The push rod and guide rods may be attached to the alignment plate by sandwiching the alignment plate with mechanical fasteners. In order to allow more rigidity and therefore, better alignment, two identical alignment plates 148 may be placed abutting one another. On threads that extend proximally of the mechanical fasteners, the grip may be attached for moving the push rod and connected structures back and forth when the push rod is not engaged by the pusher.

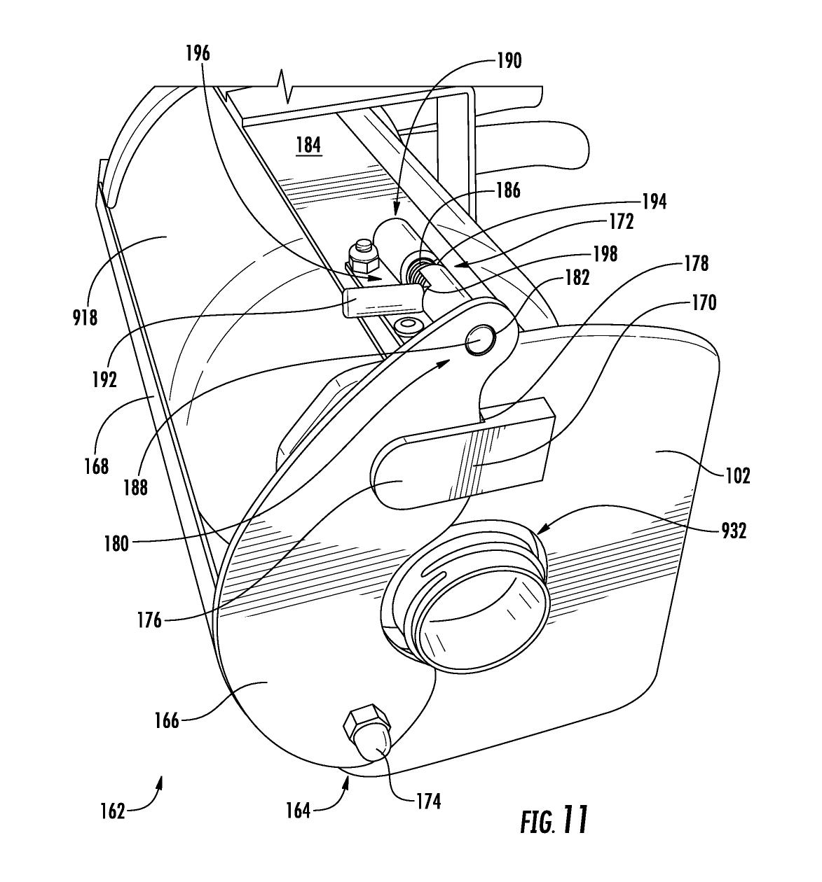

With reference to FIGS. 8-11, in operation, a user places a mixing container 918 in the application gun 88, with the neck 932 of the mixing container in the notch 104 of the face plate 102, and the bottom surface 934 of the mixing container abutting the base plate 96. If there is any extra space, or slack, between a point where the neck 932 of the mixing container meets the transition portion 944 of the mixing container, the transition portion defining that part of the mixing container which transitions from the diameter of the neck to the diameter of a body portion of the mixing container, the user may squeeze the trigger 132 of the application gun, causing the pusher 134 to grip the push rod 112, and advance the pusher and push rod forward. Upon the release of the trigger, the biasing element 140 reorients the pusher and returns it back along the push rod without engaging the push rod. Through the connection of the pusher to the trigger, the biasing element also returns the trigger to an extended position, readying the trigger for another pull by the user. Such trigger pull cycles may be repeated by a user to advance the base plate until the base plate abuts the bottom surface and the transition portion abuts the notch.

Alternatively, a user may engage the release lever 142 by placing pressure on a first end 158 of the release lever opposite a second end 144 which is pinned to the handle and trigger assembly 128. Depressing the release lever places the pusher 134 in to a neutral position where the pusher does not grip the push rod 112. A user may then use the grip 150 to push or pull the push rod, and the push rod's connection to the base plate 96 to take up any slack between the base plate and the bottom surface 534.

The user may then use the trigger 132 to apply and maintain pressure on the mixing container 918, such that an even stream of compound exits the elongate nozzle 76. Increased pressure is provided to the mixing container 18 by advancing the base plate 96. The base plate 96 applies pressure to the bottom surface 934 of the mixing container, thereby reducing the volume of the mixing container 18. The mixing container 18 is crushed and the volume of the mixing container 18 is reduced. The compound is squeezed out of the elongate nozzle. When the base plate 96 is traversed to the distal end and an inconsistent amount of compound is squeezed out of the elongate nozzle or no more compound can be squeezed out of the elongate nozzle, then the user may press the release lever 142, and pull the grip 150 to return the base plate to the proximal position clear of the mixing container, including a position abutting the proximal plate 124, and remove the spent mixing container.

The application gun 88 may further include a cover assembly 162. When used with mixing containers with a volume of a half-gallon, the application gun may include the cover assembly. However, the cover assembly 162 may be provided with all application guns 88 for mixing containers 18 of any size. The cover assembly may include a hinge element 164 which attaches to a face plate 102 of the frame 90. The face plate 102 of the frame is that part of the frame which includes the notch 104. The cover assembly further includes an upper face plate 166, a leg 168, a stiffening member 170, and a latch 172. The hinge element may attach the upper face plate to the face plate via a mechanical fastener 174, such as a nut and bolt system. The cover assembly rotates around this mechanical fastener, which defines an axis of rotation parallel to a longitudinal axis of the application gun. The longitudinal axis of the application gun is parallel to the traversal direction of the base plate 96 when the trigger is squeezed. The cover assembly may be rotated from an open position to a closed position. In the open position, the cover assembly is spaced apart from the frame. In the closed position, the cover assembly at least in part abuts the frame and the upper faceplate engages the stiffening member. The stiffening member is attached to the face plate and includes a leg portion 176 which extends parallel to, but spaced apart from, the face plate. The upper face plate rotates in to a space 178 between the leg portion and the face plate. Thus, the stiffening element provides additional stability to the upper face plate when a user advances the base plate 96 and the mixing container 918 applies pressure to the upper face plate. An engagement portion 180 of the upper face plate extends radially outside a longitudinal extension of the frame. The engagement portion includes an opening 182 to engage the latch. The latch is attached to an outer surface 184 of the frame such that a biasing element 186 in the latch biases a pin 188 to translate along an axis parallel to the longitudinal axis of the application gun, and bias the pin in to the opening in the engagement portion of the upper face plate. A housing 190 of the latch is designed such that it has a ready position in which a handle 192 attached to the pin abuts a first face 194 of a cutout 196 of the housing which is longitudinally closer to a proximal end of the housing, and compresses the biasing element between the handle and a rear of the housing, and a latching position wherein the handle abuts a second face 198 of a cutout of the housing which allows the biasing element to extend, moving the handle and the pin forward, such that the pin engages the opening. The engagement of the pin and opening prevents rotation of the cover assembly. The leg 168 of the cover assembly is attached at an apex of the upper face plate. The leg extends rearward along the frame, and terminates at the proximal end of the frame. The distal end of the leg may be removably securable to the proximal end of the frame with by example and not limitation a latch, fastener, or other mechanism. The leg does not attach to the proximal end of the frame, but instead allows the leg to flex radially away from the frame in the event that the compression of the mixing container causes the mixing container to expand radially outward from the mixing container's uncompressed position.

With the mixing container 18 disposed in the application gun 88 and the cover assembly close, the user may begin to depress to trigger in order to increase pressure within the mixing container 18 so that compound is ejected out of the elongate nozzle. The cover assembly, and more particularly the leg 168 is attached to the faceplate 166. An end of the leg 168 is not attached so that the leg 168 can deflect outward. When the mixing container 18 is being crushed, the outer walls of the mixing container 18 may expand outward. Such expansion is accommodated by the leg 168 since the leg 168 is not fixedly attached on both ends, the leg 168 can bend outward at the junction where the leg 168 is attached to the face 166.

As shown in FIG. 12, to fill a joint in concrete, a user places a mixing container 518 containing a fully mixed compound, and an elongate nozzle 76 attached, in to the application gun 88, and ensures that any slack between the application gun and the mixing container therein is taken up as described above. The user may then apply more pressure to the mixing container using the application gun as described above to apply the compound to the joint. The application gun may be carried by a standing and walking user, and the compound accurately applied from the elongate nozzle to the joint. As the application gun may be operated with the arm of the user hanging by the side, the design of the system helps reduce fatigue and increase accuracy. Further, as the application gun is oriented so that mixing container's opening is downward, the force of gravity, in addition to the pressure applied by the application gun, helps to apply the compound. The additional use of gravity helps prevent waste by draining compound from the portions of the mixing container crushed by the application gun.

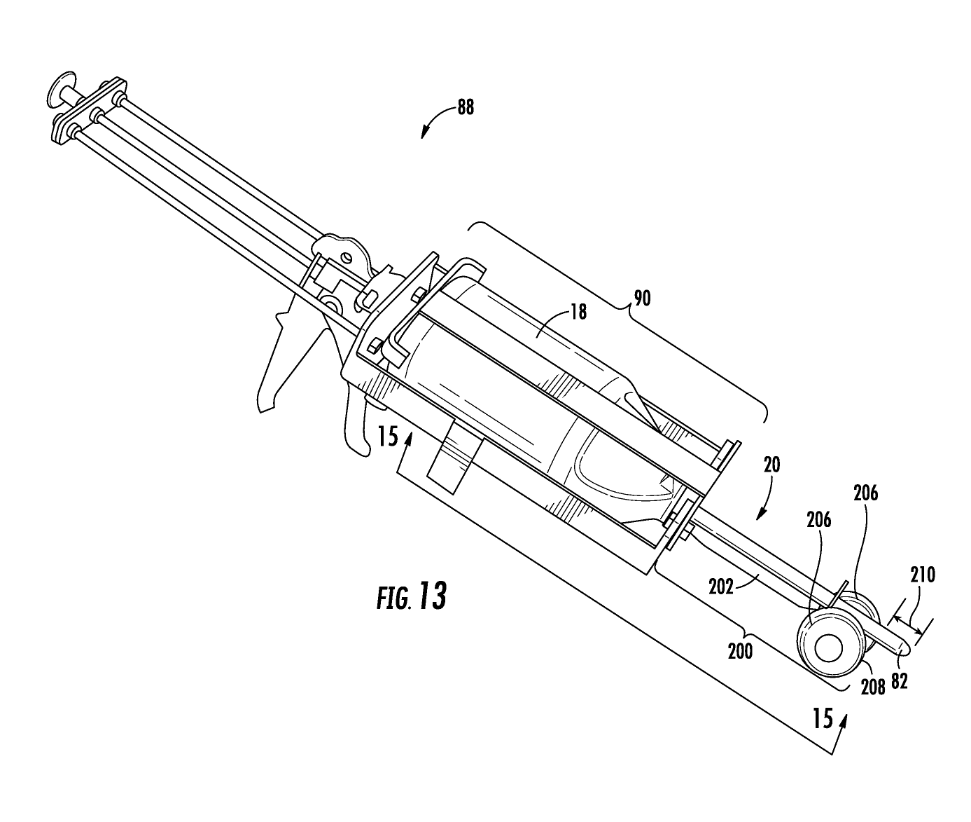

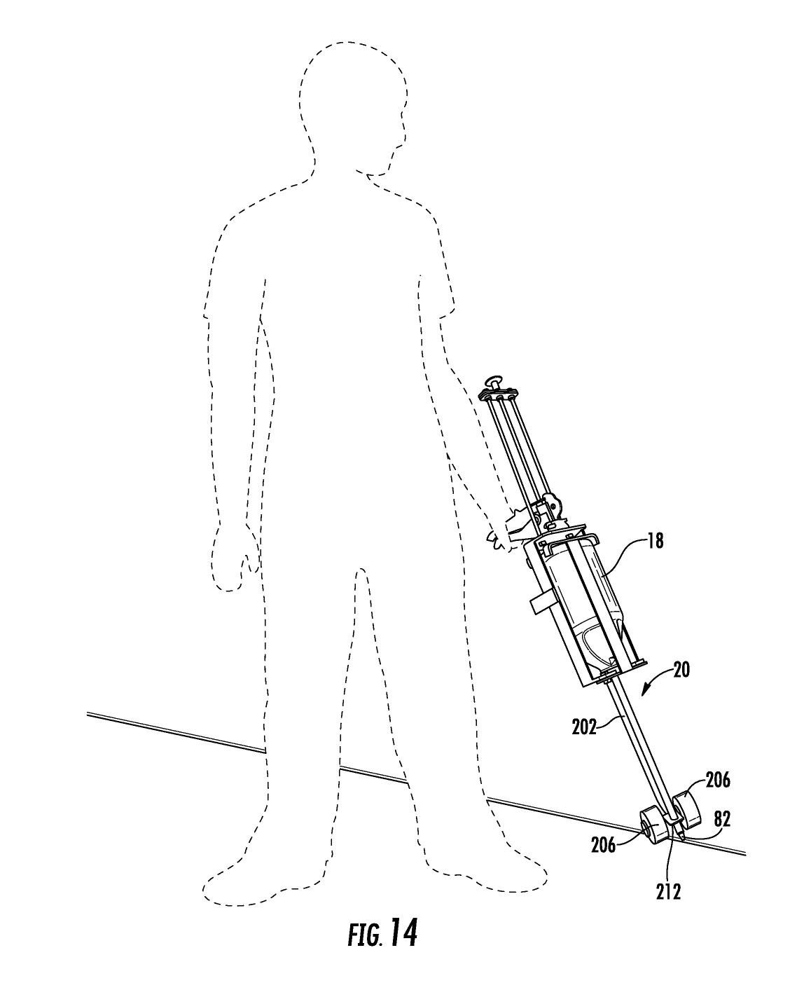

Referring now to FIGS. 13 and 14, a roller support 200 which is attached to the frame 90 of the application gun 88 is shown. The roller support 200 may have an elongate bar 202 that extends from the frame 90. By way of example and not limitation, the elongate bar 202 may be attached to the face plate 102, longitudinal frame elements 76 and/or the leg 204 (see FIG. 8). Preferably, the elongate bar 202 is attached to the face plate 102 and/or the leg 204. The elongate bar 202 extends away from the frame 90 to position one or more rollers 206 adjacent to the application tip 82 of the elongate tip 20. The rollers 206 do not extend beyond the application tip 82 but is preferably offset short of or behind from the application tip so that an outer periphery 208 of the rollers 206 is a distance 210. The distance 210 is adjusted and set so that as a user fills a crack and moves backward as shown in FIG. 14 or forward, the application tip 82 is slightly above or within the crack while the user is standing up. The rollers 206 contact the ground and support the weight of the application gun 88 and the liquid within the mixing container 18 so that the user does not get tired from the weight of the device.

The roller support 200 may have a plate 212 attached to the elongate bar 202. The plate 212 may have an aperture which receives the elongate tip 20. The application tip 82 may be disposed beyond the plate 212. The plate 212 supports the application tip 82 in position with respect to rollers 206 and to the crack or opening during use. The rollers 206 may be mounted to an axle that is attached to the elongate bar 202 or the plate 212. The rollers 206 are allowed to freely rotate while the user moves the application gun 88 forward or backwards along the crack to be sewed.

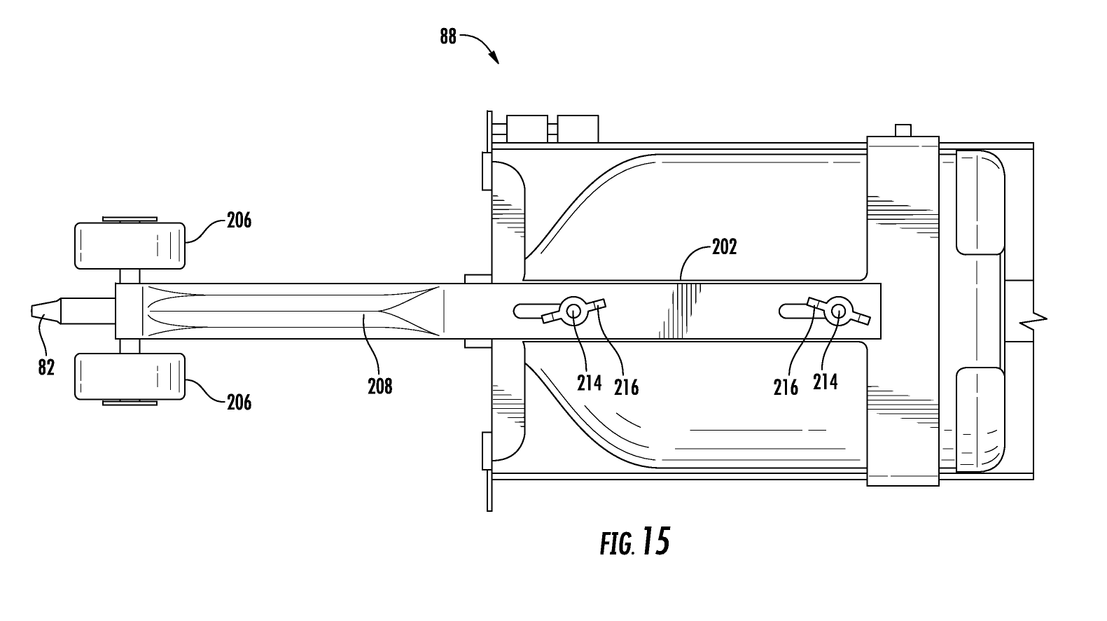

By way of example and not limitation, the distance 210 may be a quarter-inch, 1 inch, 1½ inch and 2 inches. The distance 210 may be adjustable. Referring now to FIG. 15, an underside of the application gun is shown. The elongate bar 202 may be attached to the leg 204. In particular, threaded studs 214 may be inserted through elongate slots 216 formed in the elongate bar 202. The threaded studs 214 may be attached to the leg 204. The elongate bar 202 can slide so that the rollers 206 is closer to or further away from the application tip 82 thereby adjust the distance 210 (see FIG. 13). Wingnuts can be tightened to fix the position of the elongate bar 202 on the leg 204 or loosened to adjust the distance 210 then retightened to fix the position of the elongate bar 202. The distance 210 is adjusted so that the application tip 82 is properly positioned with respect to the crack or joint which is being filled. For wide joints, the application tip 82 may be positioned to be slightly below (e.g., up to 0.375 inches below) an upper surface of the concrete as the application gun 88 is being used to fill in the joint or crack. The narrower joints, the application tip 82 may be positioned slightly above the upper surface of the concrete.

The above description is given by way of example, and not limitation. Given the above disclosure, one skilled in the art could devise variations that are within the scope and spirit of the invention disclosed herein, including various ways of packaging the various components of the compound. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A system for filling a joint formed in an upper horizontal surface of a concrete slab, the system comprising:
a deformable mixing container having an opening with an exterior threaded portion, a neck portion and a bottom surface, the deformable mixing container defining an interior cavity;
an elongate nozzle;
a fitting with an interior threaded portion engagable to the nozzle and the exterior threaded portion of the deformable plastic bottle;
a liquid A-side joint filler compound portion disposed in the deformable mixing container and filling less than 90% of the interior cavity of the deformable mixing container;
an application gun sized and configured to receive the deformable mixing container, the application gun having an enlarged base for receiving the bottom surface of the deformable mixing container, the enlarged base being larger than the bottom surface of the deformable plastic bottle, a U-shaped notch attached to a frame of the application gun for receiving the neck portion of the deformable mixing container;
a liquid B-side joint filler compound portion disposed within a first pouch;
a mixing rod having a first end portion sized and configured to be mounted to a rotation powering device, a rod portion and an opposed second end portion having two or more blades for mixing the liquid A-side joint filler and the liquid B-side joint filler;
a wiper disc with a hole formed at a central portion of the wiper disc, the hole being sized to have a diameter greater than an outer diameter of the rod portion for wiping the liquid joint filler as the mixing rod is lifted out of the deformable plastic bottle when mixing the liquid A-side joint filler compound portion, the liquid B-side joint filler compound portion, an outer diameter of the wiper disc being greater than an inner diameter of an opening of the deformable mixing container.

2. The system of claim 1 wherein the application gun further has a roller support for supporting a weight of the A and B side joint filler and application gun during use.

3. The system of claim 2 wherein the roller support has an elongate bar extending from a frame of the application gun and a roller rotatably attached to the elongate bar, and an outer periphery of the roller is offset behind the application tip of the elongate tip.

4. The system of claim 1, wherein the two or more blades have material removed to form apertures.

5. The system of claim 1 further comprising a latch for holding a cover of the application gun closed and the latch comprises a handle, a pin, a biasing element, and a cutout.

6. The system of claim 5, wherein the handle moves between two positions within the cutout.

7. The system of claim 6, wherein the biasing element biases the handle.

8. The system of claim 1, further comprising a liquid pigment, the liquid pigment being mixed with the liquid A-side and B-side joint filler compound portions in the mixing container.

9. A method of applying a joint filler to a joint in a horizontal concrete surface, the method comprising the steps of:
inserting a liquid B-side joint filler compound portion into a deformable mixing container having a liquid A-side joint filler compound portion therein;
attaching a mixing rod to a collet of a rotation powering device to impart rotation to the mixing rod;
inserting an end of the mixing rod comprising a plurality of blades into an opening of the deformable plastic bottle;
rotating the mixing rod under power of the rotation powering device to mix the liquid A-side joint filler compound portion and the liquid B-side joint filler compound portion;
holding a wiper disc against the opening of the deformable mixing container while removing the mixing rod from the deformable mixing container; stopping rotation of the mixing rod;
lifting the plurality of blades out of the deformable mixing container;
attaching an elongate nozzle to the opening of the deformable mixing container so that a user can stand generally upright while an application nozzle of the elongate nozzle is closely adjacent to the joint in the horizontal concrete surface.

10. The method of claim 9, further comprising placing the deformable mixing container in an application gun comprising a trigger.

11. The method of claim 10 further comprising the step of disposing an application tip of the elongate nozzle adjacent to a roller, the roller being attached to a frame of the application gun with an elongate bar.

12. The method of claim 10, further comprising operating the trigger to provide pressure on the deformable mixing container, expelling compound from the nozzle.

13. The method of claim 9, wherein the rotation powering device comprises a cordless drill.

14. The method of claim 9, further comprising, after the step of inserting the liquid B-side joint filler compound portion into a deformable mixing container having a liquid A-side joint filler compound portion therein; inserting a liquid pigment into the deformable mixing container having the liquid A-side joint filler compound portion therein.

15. An application gun for dispensing a liquid joint filler out of a deformable mixing container onto a joint formed in a horizontal concrete surface, the application gun comprising:
a frame defining an interior and having a notch for receiving a neck portion of the deformable mixing container;
a handle and trigger assembly, the handle and trigger assembly attached to the frame;
a base traversable, in the interior, between a first position wherein the base is disposed closer to the handle and trigger assembly when compared to the notch and a second position wherein the base is disposed closer to the notch when compared to the handle and trigger assembly;
first and second guide rods attached to the base and slidable within the frame to stabilize the base as the base is traversed between the first and second positions;
a push rod attached to the base and actuatable with the trigger to incrementally move the push rod and the base forward toward the notch as the trigger is repeatedly depressed.

16. The application gun of claim 15 wherein the application gun further has a roller support for supporting a weight of the A and B side joint filler and application gun during use.

17. The system of claim 16 wherein the roller support has an elongate bar extending from the frame of the application gun and a roller rotatably attached to the elongate bar, and an outer periphery of the roller is offset behind the application tip of the elongate tip.

18. The application gun of claim 15 further comprising a latch for a cover of the application gun closed and the latch comprises a handle, a pin, a biasing element, and a cutout.

19. The application gun of claim 15, wherein the handle moves between two positions within the cutout.

20. The system of claim 1, wherein the application gun further comprises a release lever and a grip.
